(19) United States
(12) Patent Application Publication
(10) Pub. No.: US 2005/0019214 A1
(43) Pub. Date: Jan. 27, 2005

(54) Colorable polymeric particles with biological probes

(75) Inventors: Kurt M. Schroeder, Spencerport, NY (US); Tiecheng A. Qiao, Webster, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/625,637

(22) Filed: Jul. 23, 2003

(51) Int. Cl. G01N 31/22

(52) U.S. Cl. 422/58

(57) ABSTRACT

A method of preparing polymeric particles with photographic couplers, such polymeric particles being useful in a microarray, the method comprising the steps of: (a) preparing an organic composition by combining a photographic coupler and a high boiling organic solvent; (b) preparing a separate aqueous composition comprising polymeric particles with functionally active groups on their surfaces; (c) combining the organic composition of step (a) with the aqueous composition of step (b), thereby effecting a loading of said photographic coupler and high boiling organic solvent into said polymeric particles; and (d) attaching biological probes to the functionally active groups on the surfaces of the loaded polymeric particles of step c). Polymeric particles made by the method is also disclosed.

### CROSS REFERENCE TO RELATED APPLICATIONS

This application relates to commonly assigned copending application Ser. No. ______ (DN85504), entitled COLORABLE MICROSPHERES FOR DNA AND PROTEIN MICROARRAY, application Ser. No. ______ (85507), entitled PHOTOCHROMIC DYES FOR MICROSPHERE BASED SENSOR, and application Ser. No. ______ (85677), entitled COLORABLE POLYMERIC PARTICLES WITH BIOLOGICAL PROBES, filed simultaneously herewith. The copending applications are incorporated by reference herein for all that they contain.

### FIELD OF THE INVENTION

The present invention concerns biological microarray technology in general. In particular, it concerns a method of making polymeric particles (also called microspheres) with capture agents (also called probes) on their surfaces that can interact with analytes contained in test samples. The microspheres contain photographic couplers that identify the microspheres when the color is developed. The microspheres also bear capture agents (also called probes) on their surfaces.

### BACKGROUND OF THE INVENTION

Various methods are currently known for the quantitative detection of complexes formed between specific binding agents (hereafter referred to as biological probes) and a bindable substance for biological applications. One particularly useful method is the use of colorable latex particles as the bindable substance due to their ability to absorb light in the visible spectrum, or to their ability to emit light after irradiation (fluorescence). U.S. Pat. No. 4,837,168 discloses latex particles that contain a color-forming moiety that can be covalently bound to the polymer backbone, or solvated in the latex particle. The sub-micronic particles of this invention are capable of forming color after a suitable chemical development process and hence provide a detection method when a complex is formed between a bindable substance and the colorable latex particle. However, such particles are limited in their use for two reasons. Particles in the sub-micronic range (nominally less than 100 nanometers) are difficult to detect by optical means. In addition, a polymeric bead solvated with a color forming moiety is difficult to develop into color using chemical means.

Problems to be Solved

It is an object of this invention to provide a method for the quantitative detection of complexes formed between specific biological probes and a polymeric microsphere particle which is excellent in color forming properties after a suitable chemical development step. It is a further objective of this invention to provide particles which can be easily detected due to their color or fluorescent signal. Other objects of the invention will become apparent in this disclosure.

### SUMMARY OF THE INVENTION

The invention discloses colorable particles that can be prepared for use as bindable substances in biological applications by solvating a polymeric microsphere particle with a photographic coupler and a high boiling organic solvent. High boiling organic solvents have a boiling point sufficiently high, generally above 150° C. such that they are not substantially evaporated during the particle formation steps of the present invention. The photographic coupler is capable of forming color after a suitable chemical development step.

In the invention, the photographic coupler and high boiling organic solvent are mixed and imbibed into a preformed polymeric microsphere particle that contains functional groups capable of complexing with useful biological probes. The biological probes are attached to the surface of the particles that contain the photographic couplers and high boiling solvent and the photographic couplers are converted into a detectable color signal when chemical means are employed.

The photographic couplers used in the invention are preferably superior in color forming properties and ease of detection.

The invention discloses a method of preparing polymeric particles that are useful in a microarray, the method comprising the steps of:
(a) preparing an organic composition by combining a photographic coupler and a high boiling organic solvent;
(b) preparing a separate aqueous composition comprising polymeric particles having functionally active groups on their surfaces;
(c) combining the organic composition of step (a) with the aqueous composition of step (b), thereby effecting a loading of said photographic coupler and high boiling organic solvent into said polymeric particles; and
(d) attaching biological probes to the functionally active groups on the surfaces of the loaded polymeric particles of step c).

Another aspect of the invention discloses a polymeric particle useful as a microsphere in a microarray, the polymeric particle comprising:
at least one functionally active group that can interact with a biological probe;
at least one photographic coupler;
a high boiling solvent; and
an optional surfactant.

An element comprising microspheres with photographic couplers is also disclosed.

### DETAILED DESCRIPTION OF THE INVENTION

The present invention is concerned with polymeric microsphere particles comprising one or more photographic couplers capable of forming color after a suitable chemical development step and, at least, one high boiling organic solvent. The polymeric particles of the present invention may be prepared by any of the well known techniques such as emulsion polymerization as described in “Emulsion Polymerization” by I. Piirma, Academic Press, New York (1982), dispersion polymerization as described by K. E. J. Barrett in “Dispersion Polymerization in Organic Media”, John Wiley (1975), or by limited coalescence as described by T. H. Whitesides and D. S. Ross in J. Colloid Interface Science, vol. 169, pages 48-59, (1985).

The particular polymer employed to make the particles or microspheres is any water immiscible synthetic homopolymer or copolymer that may be colored. Some representative classes of polymers useful in this invention include, but are not necessarily limited to, polyesters and addition polymers of monomers containing α,β-ethylenic unsaturation. In preferred embodiments, they may be styrenic, acrylic, or a polyester-addition polymer hybrid. By styrenic it is meant synthesized from vinyl aromatic monomers and their mixtures such as styrene, t-butyl styrene, ethylvinylbenzene, chloromethylstyrene, vinyl toluene, styrene sulfonylchloride and the like. By acrylic is meant synthesized from acrylic monomers and their mixtures such as acrylic acid, or methacrylic acid, and their alkyl esters such as methyl methacrylate, ethyl methacrylate, butyl methacrylate, methyl acrylate, ethyl acrylate, butyl acrylate, hexyl acrylate, n-octyl acrylate, lauryl methacrylate, 2-ethylhexyl methacrylate, nonyl acrylate, benzyl methacrylate, the hydroxyalkyl esters of the same acids, such as, 2-hydroxyethyl acrylate, 2-hydroxyethyl methacrylate, and 2-hydroxypropyl methacrylate and the like. By polyester-addition polymer hybrid it is meant the free radical addition reaction product of a monomer containing α,β-ethylenic unsaturation (such as a styrenic, acrylic, vinyl ester or vinyl ether) with a polyester macromonomer containing unsaturated units either pendant or along its backbone.

In a preferred embodiment of the invention, the water immiscible polymer particle contains surface functional groups capable of allowing attachment of the biological probes. Some commonly used chemical functional groups on the surface of the microspheres include, but are not limited to, carboxyl, amino, hydroxyl, hydrazide, amide, chloromethyl, epoxy, aldehyde, etc.

The microspheres are desirably formed to have a mean diameter in the range of 1 to 50 microns: more preferably in the range of 3 to 30 microns and most preferably in the range of 5 to 20 microns.

The colorable polymeric microspheres of the present invention comprise at least one compound (commonly called coupler) capable of forming color after a suitable chemical development step. Image dye-forming couplers may be included in the polymeric particle such as couplers that form cyan, magenta or yellow dyes upon reaction with oxidized color developing agents.

Couplers that form cyan dye upon reaction with oxidized color developing agents are described in such representative patents and publications as: U.S. Pat. No. 4,883,746 and “Farbkuppler—Eine Literature Ubersicht,” published in Agfa Mitteilungen, Band III, pp. 156-175 (1961). Preferably such couplers are phenols and naphthols that form cyan dyes on reaction with oxidized color developing agent. Also preferable are the cyan couplers described in, for instance, European Patent Application Nos. 491,197; 544,322; 556,700; 556,777; 565,096; 570,006; and 574,948. Examples of cyan couplers are represented, but not limited to, the following:

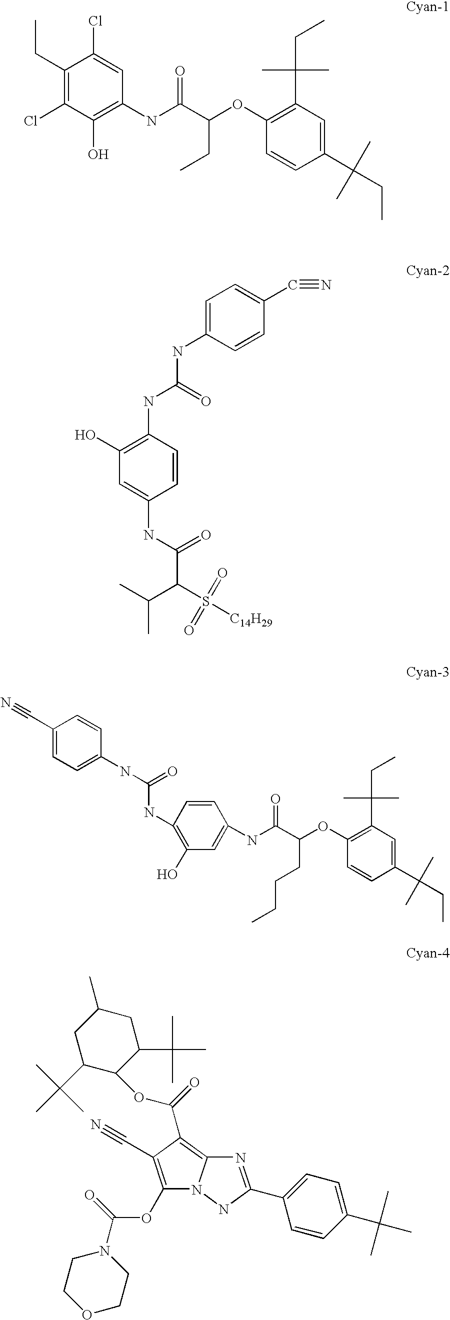

Couplers that form magenta dyes upon reaction with oxidized color developing agent are described in such representative patents and publications as: U.S. Pat. Nos. 2,311,082, 2,343,703, 2,369,489, 2,600,788, 2,908,573, 3,062,653, 3,152,896, 3,519,429, 3,758,309, and “Farbkuppler-eine Literature Ubersicht,” published in Agfa Mitteilungen, Band III, pp. 126-156 (1961). Preferably such couplers are pyrazolones, pyrazolotriazoles, or pyrazolobenzimidazoles that form magenta dyes upon reaction with oxidized color developing agents. Especially preferred couplers are 1H-pyrazolo [5,1-c]-1,2,4-triazole and 1H-pyrazolo [1,5-b]-1,2,4-triazole. Examples of 1H-pyrazolo [5,1-c]-1,2,4-triazole couplers are described in U.K. Patent Nos. 1,247,493; 1,252,418; 1,398,979; U.S. Pat. Nos. 4,443,536; 4,514,490; 4,540,654; 4,590,153; 4,665,015; 4,822,730; 4,945,034; 5,017,465; and 5,023,170. Examples of 1H-pyrazolo [1,5-b]-1,2,4-triazoles can be found in European Patent applications 176,804; 177,765; U.S. Pat. Nos. 4,659,652; 5,066,575; and 5,250,400.

Typical pyrazoloazole and pyrazolone couplers are represented by the following formulas: 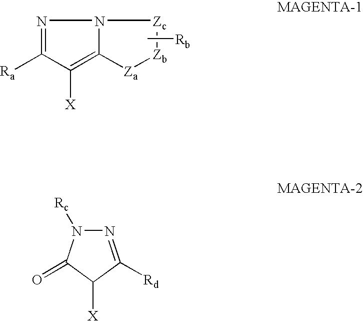
wherein Rₐ and R_{b} independently represent H or a substituent; R_{c} is a substituent (preferably an aryl group); R_{d} is a substituent (preferably an anilino, carbonamido, ureido, carbamoyl, alkoxy, aryloxycarbonyl, alkoxycarbonyl, or N-heterocyclic group); X is hydrogen or a coupling-off group; and Zₐ, Z_{b}, and Z_{c} are independently a substituted methine group, ═N—, ═C—, or —NH—, provided that one of either the Zₐ-Z_{b} bond or the Z_{b}-Z_{c} bond is a double bond and the other is a single bond, and when the Z_{b}-Z_{c} bond is a carbon-carbon double bond, it may form part of an aromatic ring, and at least one of Zₐ, Z_{b}, and Z_{c} represents a methine group connected to the group R_{b}.

Illustrative examples of magenta dye forming couplers useful in this invention include:

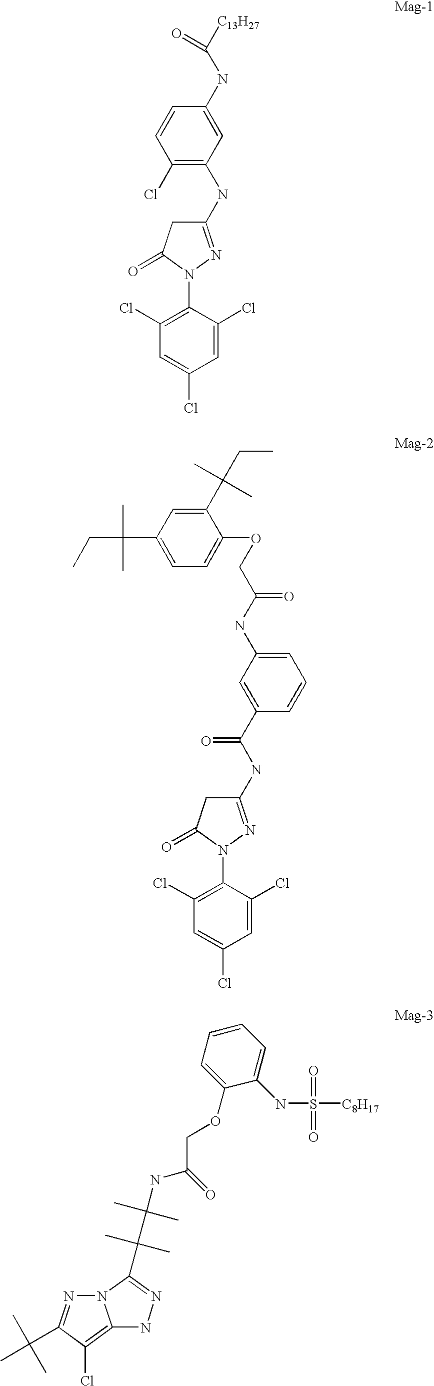

Couplers that form yellow dyes upon reaction with oxidized color developing agent are described in such representative patents and publications as: U.S. Pat. Nos. 2,298,443; 2,407,210; 2,875,057; 3,048,194; 3,265,506; 3,447,928; 3,960,570; 4,022,620; 4,443,536; 4,910,126; and 5,340,703 and “Farbkuppler-eine Literature Ubersicht,” published in Agfa Mitteilungen, Band III, pp. 112-126 (1961). Such couplers are typically open chain ketomethylene compounds. Also preferred are yellow couplers such as described in, for example, European Patent Application Nos. 482,552; 510,535; 524,540; 543,367; and U.S. Pat. No. 5,238,803. For improved color reproduction, couplers which give yellow dyes that cut off sharply on the long wavelength side are particularly preferred (for example, see U.S. Pat. No. 5,360,713).

Typical preferred yellow couplers are represented by the following formulas: 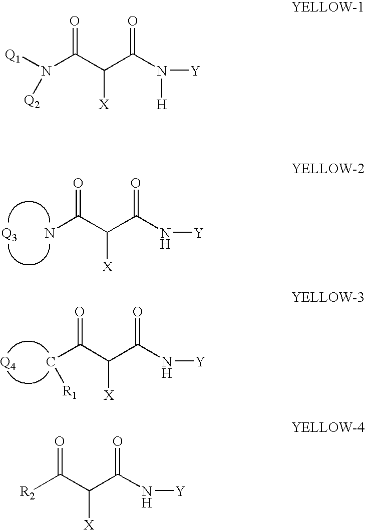
wherein R₁, R₂, Q₁ and Q₂ each represents a substituent; X is hydrogen or a coupling-off group; Y represents an aryl group or a heterocyclic group; Q₃ represents an organic residue required to form a nitrogen-containing heterocyclic group together with the >N—; and Q₄ represents nonmetallic atoms necessary to from a 3- to 5-membered hydrocarbon ring or a 3- to 5-membered heterocyclic ring which contains at least one hetero atom selected from N, O, S, and P in the ring. Particularly preferred is when Q₁ and Q₂ each represent an alkyl group, an aryl group, or a heterocyclic group, and R₂ represents an aryl or tertiary alkyl group.

Illustrative examples of yellow dye forming couplers useful in this invention include:

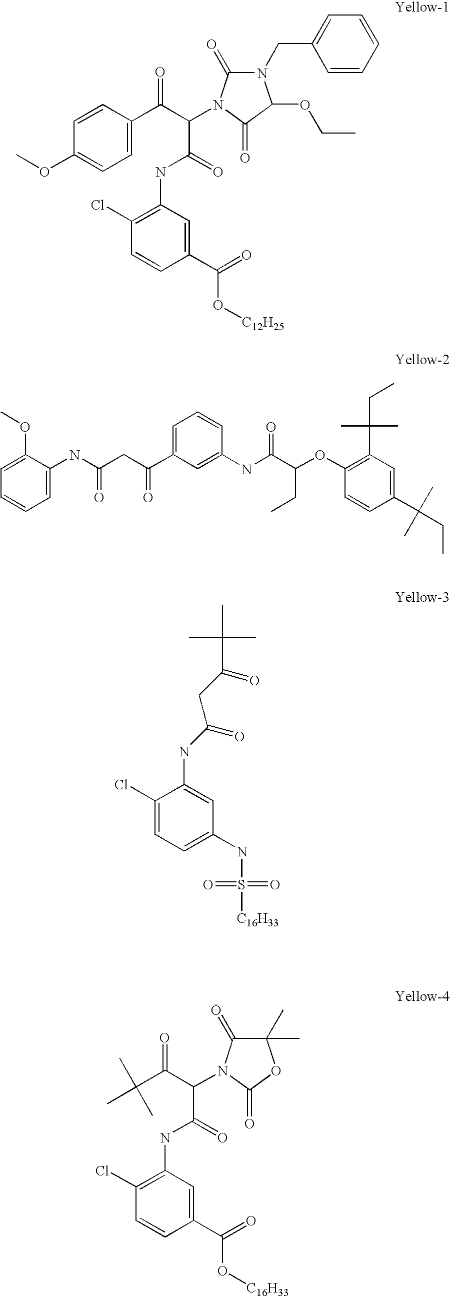

The inventive polymeric particle also contains, in addition to the photographic coupler, at least one high boiling organic solvent. The high boiling organic solvent of the present invention can be chosen from a broad class of compounds including: alkyl phthalates, aryl phthalates, alkyl amides, phosphates, phenols, alcohols, sulfoxides, esters, hydrocarbons, alkyl halides, epoxides and the like. Solvents applicable to the inventive particles of this disclosure are, for example: diethyl phthalate, dibutyl phthalate, dipentyl phthalate, diisoamyl phthalate, dibenzyl phthalate, dimethoxyethyl phthalate, dibutoxyethyl phthalate, tributyl trimellitate, acetyltributyl citrate, tributyl citrate, tripentyl citrate, dimethyl sebacate, dibutyl sebacate, dibutyl adipate, dibutyl azelate, 1,4-cyclohexylenedimethylene bis(2-ethylhexanaoate), bis-ethylhexyl sulfoxide, triphenylphosphate, tricresylphosphate, trihexylphosphate, n-Hexylphenylcarbinol, 2-(p-tert, butylphenoxy)-ethanol, Acetyl n-butyl aniline, N-n-amyl succinimide, N,N-di-propyl dodecanamide, N-dodecyl pyrolidinone, di-tert amyl phenol, phenoxy toluene, ethylhexyl hydroxy benzoate, phenylethyl benzoate, ethylhexyltoluene sulfonamide, undecyl alcohol, oleyl alcohol, butyl methoxy benzoate, butyl phthalylbutyl glycollate, and N,N′-di-n-butyl urea.

The photographic couplers and high boiling organic solvents may be imbibed into the polymeric microsphere particle by any of the well known techniques of loading photographically useful compounds into polymer latexes such as; U.S. Pat. Nos. 4,199,363, 4,247,627, 4,368,258, 5,594,047, and U.K. 2016017. Included in these techniques is the process by which the color forming compound is first dissolved in the high boiling organic solvent, and optionally, either a volatile organic solvent or partially water miscible solvent, and the resulting organic solution is homogenized in the presence of a surface active agent to form a small particle dispersion of the organic composition. This composition is then mixed with the polymeric microspheres to achieve a homogeneous composition of organic compounds in the polymer particle. If an optional solvent is used, that is, either a volatile organic solvent or partially water miscible solvent, then an additional step is added to remove the auxiliary volatile or water miscible solvents resulting in polymeric particles (microspheres) loaded with photographic coupler and high boiling organic solvent imbibed in the process.

Suitable volatile solvents useful in the invention include: methyl acetate, ethyl acetate, methyl ethyl ketone, isopropyl acetate, n-propyl acetate, methyl isobutyl ketone, butyl acetate, 2-methyl tetrahydrofuran, methylene chloride, 1,1,2-trichloroethane, and 1,2-dichloropropane. Suitable water miscible solvents useful in the invention include: acetone, diacetone alcohol, dipropylene glycol methyl ether, propylene glycol propyl ether, ethanol, isopropanol, n-propanol, cyclohexanone, and butoxyethoxy ethyl acetate.

The amount of dye forming coupler and high boiling organic solvent that can be imbibed into the polymer particle will depend on the solubility of said organic compounds within the microsphere and, are therefore a function of both polymer and organic compound chemical structure. The desired loading ratio of the color forming coupler and high boiling solvent will be a function of the extinction of the formed dye and ability to develop dye in an efficient chemical development step with the understanding that maximum dye density formation is desirable. In a preferred embodiment, the dye forming coupler and high boiling organic solvent together are solvated into the polymeric particle in a ratio of polymer to coupler/high boiling solvent (that is, coupler and high boiling solvent combined) of about 1:1 to 20:1 on a weight basis, more preferred from about 1:1 to 10:1 and most preferred from about 1:1 to 3:1.

The polymeric colorable particles of the present invention, containing at least one color forming compound and at least one high boiling organic solvent, are also comprised of a bioactive probe attached to said microsphere surface. As used herein, bioactive probes include, but are not limited to, polynucleotide, polypeptide, polysaccharides, and small synthetic molecules that are capable of interacting specifically with certain biological targets. Preferred bioactive probes are nucleic acids and proteins.

Nucleic acids are polynucleotide biological molecules that carry genetic information. There are two basic kinds of nucleic acids and they are deoxyribonucleic acid (DNA) and ribonucleic acid (RNA). A DNA molecule consists of four nucleotide bases, A, T, G, and C, which are connected in linear manner covalently; and a RNA molecule consists of four bases, A, U, G, and C, which are connected in linear manner covalently. The interaction among four bases follows the “Watson-Crick” base pairing rule of A to T (U) and G to C mediated by hydrogen bonds. When two single strand DNA molecules having a perfect “Watson-Crick” base paring match, they are referred as a complementary strand. The interaction between two complementary strands is termed hybridization. As such, a single-stranded DNA or RNA can be used as a bioactive probe to interact with its complementary strand. Sometimes, the complementary strand may contain one or more base-pairing mismatches as well.

Some commonly used nucleic acid bioactive probes which can used in the invention include, but not limited to, DNA and DNA fragments, RNA and RNA fragment, synthetic oligonucleotides, and peptide nucleic acids. In another embodiment of the invention, the nucleic acid bioactive probes can be any protein scaffold or synthetic molecular moiety capable of recognizing a specific DNA sequence. A nucleic acid bioactive probe can be terminally modified to contain one or more than one chemical functional groups that can be used to attached to another molecule or a surface. Some commonly used terminal modifications include, but not limited to, amino, thiol, carboxyl, biotin, and digoxigenin.

A protein molecule consists of 20 amino acids that are connected in linear manner covalently. Some proteins can be further modified at selected amino acids through posttranslational processes that include phosphorylation and glycosylation. A protein molecule can be used as a bioactive probe. Protein bioactive probes can interact with proteins in high affinity and high specificity. Typically it is desirable to have an affinity binding constant between a protein bioactive probe and target protein greater than 10⁶ M⁻¹.

There are several classes of molecules that can be used as protein bioactive probes. Antibodies are a class of naturally occurring protein molecules that are capable of binding targets with high affinity and specificity. The properties and protocols of using antibody can be found in “Using Antibodies; A Laboratory Manual”, (Cold Spring Harbor Laboratory Press, by Ed Harlow and David Lane, Cold Spring Harbor, N.Y. 1999). Antigens can also be used as protein bioactive probes if antibodies are intended targets for detection. Protein scaffolds such as whole protein/enzyme or their fragments can be used as protein bioactive probes as well. Examples include phosphotases, kinases, proteases, oxidases, hydrolyases, cytokines, or synthetic peptides. Nucleic acid ligands can be used as protein bioactive probes after in vitro selection and enrichment for their binding affinity and specificity to certain targets. The principle of such selection process can be found in Science, Vol. 249, 505-510, 1990 and Nature, Vol. 346, 818-822, 1990. U.S. Pat. No. 5,110,833 discloses an alternative class of synthetic molecules that can mimic antibody binding affinity and specificity and can be readily prepared by the so called Molecular Imprinting Polymer (MIP). This technology has been reviewed in Chem. Rev. Vol. 100, 2495-2504, 2000.

The attachment of nucleic acid bioactive probes and protein bioactive probes to the surface of chemically functionalized microspheres can be performed according to the published procedures in the art (Bangs Laboratories, Inc, Technote #205). In a preferred embodiment, one microsphere is only associated with one type of bioactive probe. It is also preferred that the bioactive probes are synthesized first, and then covalently attached to the microspheres. However, as will be appreciated by those in the art, the bioactive probes can also be synthesized in situ on the microspheres. By either ways, linkers of various lengths can be used to connect bioactive probes with the microspheres to provide flexibility for optimized interactions between the bioactive probes and the target molecules.

The colorable polymeric microspheres, containing photographic couplers, high boiling organic solvent and surface attached bioactive probes form color through a chemical development step. The color developing concentrates of this disclosure include one or more color developing agents that are well known in the art that, in oxidized form, will react with dye forming color couplers in the processed materials. Such color developing agents include, but are not limited to, aminophenols, p-phenylenediamines (especially N,N-dialkyl-p-phenylenediamines) and others which are well known in the art, such as EP 0 434 097A1 (published Jun. 26, 1991) and EP 0 530 921A1 (published Mar. 10, 1993). It may be useful for the color developing agents to have one or more water-solubilizing groups as are known in the art. Further details of such materials are provided in Research Disclosure, publication 38957, pages 592-639 (September 1996). Research Disclosure is a publication of Kenneth Mason Publications Ltd., Dudley House, 12 North Street, Emsworth, Hampshire PO10 7DQ England (also available from Emsworth Design Inc., 121 West 19th Street, New York, N.Y. 10011). This reference will be referred to hereinafter as “Research Disclosure”.

Preferred color developing agents include, but are not limited to, N,N-diethyl p-phenylenediamine sulfate (KODAK Color Developing Agent CD-2), 4-amino-3-methyl-N-(2-methane sulfonamidoethyl)aniline sulfate, 4-(N-ethyl-N-□-hydroxyethylamino)-2-methylaniline sulfate (KODAK Color Developing Agent CD-4), p-hydroxyethylethylaminoaniline sulfate, 4-(N-ethyl-N-2-methanesulfonylaminoethyl)-2-methylphenylenediamine sesquisulfate (KODAK Color Developing Agent CD-3), 4-(N-ethyl-N-2-methanesulfonylaminoethyl)-2-methylphenylenediamine sesquisulfate, and others readily apparent to one skilled in the art.

In order to protect the color developing agents from oxidation, one or more antioxidants are generally included in the color developing compositions. Either inorganic or organic antioxidants can be used. Many classes of useful antioxidants are known, including but not limited to, sulfites (such as sodium sulfite, potassium sulfite, sodium bisulfite and potassium metabisulfite), hydroxylamine (and derivatives thereof), hydrazines, hydrazides, amino acids, ascorbic acid (and derivatives thereof), hydroxamic acids, ammonium salts, nitroxy radicals, alcohols, and oximes. Also useful as antioxidants are 1,4-cyclohexadiones. Mixtures of compounds from the same or different classes of antioxidants can also be used if desired.

Especially useful antioxidants are hydroxylamine derivatives as described for example, in U.S. Pat. No. 4,892,804, U.S. Pat. No. 4,876,174, U.S. Pat. No. 5,354,646, and U.S. Pat. No. 5,660,974, all noted above, and U.S. Pat. No. 5,646,327 (Burns et al). Many of these antioxidants are mono- and dialkylhydroxylamines having one or more substituents on one or both alkyl groups. Particularly useful alkyl substituents include sulfo, carboxy, amino, sulfonamido, carbonamido, hydroxy and other solubilizing substituents.

More preferably, the noted hydroxylamine derivatives can be mono- or dialkylhydroxylamines having one or more hydroxy substituents on the one or more alkyl groups. Representative compounds of this type are described, for example, in U.S. Pat. No. 5,709,982 (Marrese et al), incorporated herein by reference, as having the structure I: 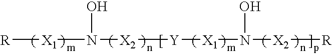
wherein R is hydrogen, a substituted or unsubstituted alkyl group of 1 to 10 carbon atoms, a substituted or unsubstituted hydroxyalkyl group of 1 to 10 carbon atoms, a substituted or unsubstituted cycloalkyl group of 5 to I0 carbon atoms, or a substituted or unsubstituted aryl group having 6 to 10 carbon atoms in the aromatic nucleus.

X, is —CR₂(OH)CHR₁— and X₂ is —CHR₁CR₂(OH)— wherein R₁ and R₂ are independently hydrogen, hydroxy, a substituted or unsubstituted alkyl group or 1 or 2 carbon atoms, a substituted or unsubstituted hydroxyalkyl group of 1 or 2 carbon atoms, or RI and R₂ together represent the carbon atoms necessary to complete a substituted or unsubstituted 5- to 8-membered saturated or unsaturated carbocyclic ring structure.

Y is a substituted or unsubstituted alkylene group having at least 4 carbon atoms, and has an even number of carbon atoms, or Y is a substituted or unsubstituted divalent aliphatic group having an even total number of carbon and oxygen atoms in the chain, provided that the aliphatic group has a least 4 atoms in the chain.

Also in Structure I, m, n and p are independently 0 or 1. Preferably, each of m and n is 1, and p is 0.

Specific di-substituted hydroxylamine antioxidants include, but are not limited to: N,N-bis(2,3-dihydroxypropyl)hydroxylamine, N,N-bis(2-methyl-2,3-dihydroxypropyl)hydroxylamine and N,N-bis(1-hydroxymethyl-2-hydroxy-3-phenylpropyl)hydroxylamine. The first compound is preferred.

The invention is further illustrated by the following examples in which parts and percentages are by weight unless otherwise specified.

### EXAMPLES

Preparation of Colorable Polymeric Particles

Preparation of AQS-1.

An aqueous suspension of colorable polymeric particles was prepared by dissolving 0.08 grams of coupler Cyan-1 in 0.08 grams of tricresyl phosphate and 0.8 grams cyclohexanone. This organic phase was then homogenized into an aqueous composition comprising 0.5 grams of a 10% solution of Alkanol XC (Dupont) surfactant and 6.6 grams of deionized water using a sonic mixer.

4.0 grams of the sub-micronic dispersion was then mixed with 4.0 grams of a 4.2% carboxylate surface-functionalized polystyrene microsphere bead suspension (Interfacial Dynamics Corporation) and allowed to equilibrate with stirring. The resulting coupler and solvent loaded microspheres were then poured into a diafiltration bag and washed for six hours to remove the cyclohexanone. The resulting aqueous suspension is denoted as AQS-1.

Preparation of AQS-2.

A similar procedure to prepare AQS-1 was used to prepare a suspension of colorable latex particles except that Cyan-1 was imbibed into the polystyrene microspheres without the use of tricresyl phosphate. The resulting aqueous suspension is denoted as AQS-2.

An aqueous suspension of colorable polymeric particles was prepared by dissolving 1.0 grams of coupler Magenta-1 in 1.0 grams of tricresyl phosphate and 10.0 grams cyclohexanone. This organic phase was then homogenized into an aqueous composition comprising 6.0 grams of a 10% solution of Alkanol XC (Dupont) surfactant and 81.5 grams of deionized water using a Silverson rotor-stator. The resulting premix was passed one time through a Microfluidics model 110F microfluidizer at 7,000 psi to form a dispersion of sub-micronic oil droplets (homogeneous mixture of coupler and high boiling organic solvent) in water.

Preparation of AQS-3.

4.0 grams of the sub-micronic dispersion was then mixed with 4.0 grams of a 4.2% carboxylate surface-functionalized polystyrene microsphere bead suspension (Interfacial Dynamics Corporation) and allowed to equilibrate with stirring. The resulting coupler and solvent loaded microspheres were then poured into a diafiltration bag and washed for six hours to remove the cyclohexanone. The resulting aqueous suspension is denoted as AQS-3.

Preparation of AQS-4.

A similar procedure to prepare AQS-3 was used to prepare a suspension of colorable latex particles except that dibutyl sebacate was used in place of tricresyl phosphate. The resulting aqueous suspension is denoted as AQS-4.

An aqueous suspension of colorable polymeric particles was prepared by dissolving 1.0 grams of coupler Yellow-4 in 1.0 grams of dibutyl phthalate and 10.0 grams cyclohexanone. This organic phase was then homogenized into an aqueous composition comprising 6.0 grams of a 10% solution of Alkanol XC

(Dupont) surfactant and 81.5 grams of deionized water using a Silverson rotor-stator. The resulting premix was passed one time through a Microfluidics model 110F microfluidizer at 7,000 psi to form a dispersion of sub-micronic oil droplets (homogeneous mixture of coupler and high boiling organic solvent) in water.

Preparation of AQS-5.

4.0 grams of the sub-micronic dispersion was then mixed with 4.0 grams of a 4.2% carboxylate surface-functionalized polystyrene microsphere bead suspension (Interfacial Dynamics Corporation) and allowed to equilibrate with stirring. The resulting coupler and solvent loaded microspheres were then poured into a diafiltration bag and washed for six hours to remove the cyclohexanone. The resulting aqueous suspension is denoted as AQS-5.

Preparation of AQS-6.

A similar procedure to prepare AQS-5 was used to prepare a suspension of colorable latex particles except that Yellow-4 was imbibed into the polystyrene microspheres without the use of dibutyl phthalate. The resulting aqueous suspension is denoted as AQS-6.

Attachment of DNA Probe to Polymeric Particle

This example illustrates the attachment of pre-synthesized single strand oligonucleotide probe to the surface of coupler incorporated microspheres. One hundred microliters of coupler incorporated microspheres (4% w/v) was rinsed three times in acetate buffer (0.01 M, pH5.0), and combined with one hundred microliters of 20 mM 2-(4-Dimethylcarbomoyl-pyridino)-ethane-1-sulfonate and ten percent of polyethyleneimine. The mixture was agitated at room temperature for one hour and rinsed three times with sodium boric buffer (0.05 M, pH8.3). The beads were re-suspended in sodium boric buffer.

An oligonucleotide DNA probe with 5′-amino-C6 modification was dissolved in one hundred microliters of sodium boric buffer to a final concentration of 40 nmol. A 20 microliters of cyanuric chloride in acetonitril was added to the DNA probe solution and the total volume was brought up to 250 microliter using sodium boric buffer. The solution was agitated at room temperature for one hour and then dialyzed against one liter of boric buffer at room temperature for three hours.

A 100 microliters of the dialyzed DNA solution was mixed with 200 microliters of beads suspension. The mixture was agitated at room temperature for one hour and rinsed three times with sodium phosphate buffer (0.01 M, pH7.0).

Attachment of Antibody Probe to Polymeric Particle

This example illustrates the attachment of an antibody bioactive probe to the surface of coupler incorporated microspheres.

One hundred microliters of coupler incorporated microspheres (4% w/v) was rinsed three times in acetate buffer (0.01 M, pH5.0), and combined with one milliliter of 50 mM 2-(4-Dimethylcarbomoyl-pyridino)-ethane-1-sulfonate. The mixture was agitated at room temperature for one hour and rinsed three times with sodium acetate buffer (0.01 M, pH5.0). A goat-anti-mouse IgG of 1 mg was added to the microspheres along with one milliliter of sodium acetate buffer (0.01 M, pH5.0). The mixture was agitated at room temperature for one hour and rinsed three times with 0.01 M phosphate saline buffer pH 7.0. Such antibody modified microspheres are ready for further uses.

Hybridization and Detection of Target Nucleic Acid

This example illustrates the hybridization and detection of target nucleic acid sequences to the gelatin coated microsphere on a glass support.

An oligonucleotide DNA with 5′-Cy3 labeling, which has complementary sequence to the DNA probe attached to the surface of the microspheres was dissolved in a hybridization solution containing 0.9 M NaCl, 0.06 M NaH₂PO₄, 0.006 M EDTA, and 0.1% SDS, pH 7.6 (6×SSPE-SDS) to a final concentration of 1M. A microscope glass slide was first coated with a layer of gelatin by spreading 50 microliters of 2.5 % gelatin solution on the surface of the glass slide. After the gelatin, a microsphere suspension of 1% prepared according to Example 3 containing 0.5% of bis(vinylsulfonyl) methane were applied onto the gelatin pre-coated glass slide and were allowed to dry to immobilize microspheres on 2-dimensional surface of the glass slide. The bead coated glass slide was hybridized in the hybridization solution starting at room temperature for 1 hour. Following hybridization, the slide was washed in 0.5×SSPE-SDS for 15 minutes three times.

The hybridization completed slide was imaged with an Olympus BH-2 fluorescence microscope (Diagnostic Instruments, Inc. SPOT camera, CCD resolution of 1315×1033 pixels) to detect the fluorescence signals resulted from DNA hybridization on the surface of the microspheres.

Detection of Protein Target Molecule

This example illustrates the detection of protein target molecule to the gelatin coated microsphere on a glass support.

Mouse IgG of 0.001 mg/mL labeled with Cy3 or Cy5 was prepared in 0.05 M phosphate buffer, and combined with a suspension of 1% goat-anti-mouse modified microspheres as described above to a total volume of one milliliter. The mixture was incubated at room temperature with gentle agitation for one hour. The beads were spun down after the incubation and rinsed three times in phosphate buffer pH7.0 0.1% tween 20. A microscope glass slide was first coated with a layer of gelatin by spreading 50 microliters of 2.5% gelatin solution on the surface of the glass slide. After the gelatin, a microsphere suspension of 1% containing 0.5% of bis(vinylsulfonyl) methane were applied onto the gelatin pre-coated glass slide and were allowed to dry to immobilize microspheres on 2-dimensional surface of the glass slide.

After drying, the glass slide was imaged with an Olympus BH-2 fluorescence microscope (Diagnostic Instruments, Inc. SPOT camera, CCD resolution of 1315×1033 pixels) to detect the fluorescence signals resulted from protein interactions on the surface of the microspheres.

Development of Coupler Incorporated Microspheres

This example illustrates the development of coupler incorporated microspheres into color on a gelatin coated glass support.

For each sample development, 1 mL of microspheres was washed twice with pH 10.10, 0.1 M sodium carbonate buffer and then the microspheres were re-suspended to 0.6 mL in either the pure carbonate buffer or the carbonate buffer containing a small percentage of Benzyl alcohol (3.5%). Thereupon, 0.2 mL of a developer solution with 3.5 g/L para-phenylenediamine in degassed water was added, followed by 0.2 mL of an oxidizing solution of 20 g/L of K₂S₂O₈ in water. The microsphere mixture was allowed to react for 30 minutes at room temperature with agitation. The microsphere solution was then spun down for 1.5 minutes and rinsed twice with water. A microscope glass slide was first coated with a layer of gelatin by spreading 50 microliters of 2.5% gelatin solution on the surface of the glass slide. After the gelatin, a microsphere suspension of 1% containing 0.5% of bis(vinylsulfonyl) methane were applied onto the gelatin pre-coated glass slide and were allowed to dry to immobilize microspheres on 2-dimensional surface of the glass slide.

The above described processes for attaching biological probes and the subsequent hybridization and detection of target nucleic acid sequences to the gelatin coated microsphere was applied to colorable microspheres in examples AQS-1 to AQS-6.

The color development steps outlined above was used to switch the essentially colorless microspheres to colored microspheres. The microspheres were viewed using an Olympus BH-2 microscope (Diagnostic Instruments, Inc. SPOT camera, CCD resolution of 1315×1033 pixels) to detect the color signals. Table 1 illustrates the results.

TABLE 1

| Microspheres | | Result of Color Formation |
|---|---|---|
| AQS-1 | invention | Strong cyan color formation in the beads |
| AQS-2 | comparison | Faint cyan color formation in the beads |
| AQS-3 | invention | Strong magenta color formation in the |
| | | beads |
| AQS-4 | invention | Strong magenta color formation in the |
| | | beads |
| AQS-5 | invention | Strong yellow color formation in the beads |
| AQS-6 | comparison | Faint yellow color formation in the beads |

1. A method of preparing polymeric particles with photographic couplers, such polymeric particles being useful in a microarray, the method comprising the steps of:
(a) preparing an organic composition by combining a photographic coupler and a high boiling organic solvent;
(b) preparing a separate aqueous composition comprising polymeric particles with functionally active groups on their surfaces;
(c) combining the organic composition of step (a) with the aqueous composition of step (b), thereby effecting a loading of said photographic coupler and high boiling organic solvent into said polymeric particles; and
(d) attaching biological probes to the functionally active groups on the surfaces of the loaded polymeric particles of step c).

2. The method of claim 1 wherein the organic composition of step a) further contains a volatile or water-miscible auxiliary solvent.

3. The method of claim 1 wherein step b) further includes adding a surfactant to the aqueous composition.

4. The method of claim 1 wherein the polymeric particles are formed by emulsion polymerization, dispersion polymerization, or by limited coalescence.

5. The method of claim 1 wherein the polymeric particles are formed from styrenic polymers, acrylic polymers, or from a polyester-addition polymer hybrid.

6. The method of claim 1 wherein the polymeric particles have a mean diameter of 1 to 50 microns.

7. The method of claim 1 wherein the polymeric particles have a mean diameter of 3 to 30 microns.

8. The method of claim 1 wherein the polymeric particles have a mean diameter of 5 to 20 microns.

9. The method of claim 1 wherein the functionally active groups on the surfaces of the polymeric particles can interact with biological probes.

10. The method of claim 1 wherein the functionally active group on the surfaces of the polymeric particles are carboxyl, amino, hydroxyl, hydrazide, amide, chloromethyl, epoxy, or aldehyde.

11. The method of claim 1 wherein the biological probes are covalently or noncovalently attached to the surfaces of the loaded polymeric particles.

12. The method of claim 1 wherein the coupler in the loaded polymeric particle can be developed to form a detectable color.

13. The method of claim 12 wherein the color formed upon development identifies the polymeric particle.

14. The method of claim 12 wherein the photographic coupler is developed by interacting with oxidizing color developing agents to form cyan, magenta or yellow dyes.

15. The method of claim 14 wherein the photographic coupler is a phenol or a naphthol that forms cyan dyes.

16. The method of claim 14 wherein the photographic coupler is a pyrazolone, pyrazolotriazole, or pyrazolobenzimidazole that forms magenta dyes.

17. The method of claim 14 wherein the dye-forming coupler is an open chain ketomethylene compound that forms yellow dyes.

18. The method of claim 1 wherein the high boiling organic solvent is selected from the group of compounds consisting of alkyl phthalates, aryl phthalates, alkyl amides, phosphates, phenols, alcohols, sulfoxides, esters, hydrocarbons, alkyl halides, and epoxides.

19. The method of claim 1 wherein the high boiling organic solvent is selected from the group of compounds consisting of diethyl phthalate, dibutyl phthalate, dipentyl phthalate, diisoamyl phthalate, dibenzyl phthalate, dimethoxyethyl phthalate, dibutoxyethyl phthalate, tributyl trimellitate, acetyltributyl citrate, tributyl citrate, tripentyl citrate, dimethyl sebacate, dibutyl sebacate, dibutyl adipate, dibutyl azelate, 1,4-cyclohexylenedimethylene bis(2-ethylhexanaoate), bis-ethylhexyl sulfoxide, triphenylphosphate, tricresylphosphate, trihexylphosphate, n-Hexylphenylcarbinol, 2-(p-tert, butylphenoxy)-ethanol, Acetyl n-butyl aniline, N-n-amyl succinimide, N,N-di-propyl dodecanamide, N-dodecyl pyrolidinone, di-tert amyl phenol, phenoxy toluene, ethylhexyl hydroxy benzoate, phenylethyl benzoate, ethylhexyltoluene sulfonamide, undecyl alcohol, oleyl alcohol, butyl methoxy benzoate, butyl phthalylbutyl glycollate, and N,N′-di-n-butyl urea.

20. The method of claim 1 wherein the weight ratio of the combined photographic coupler and high boiling solvent of step a) to the polymeric particles of step b) is between 1:1 and 20:1.

21. The method of claim 1 wherein the weight ratio of the combined photographic coupler and high boiling solvent of step a) to the polymeric particles of step b) is between 1:1 and 3:1.

22. The method of claim 2 wherein the volatile or water-miscible auxiliary solvent is removed in an additional step after step c) and before step d).

23. The method of claim 22 wherein the auxiliary solvent is removed by evaporation or dialysis.

24. A polymeric particle for use in a microarray, the polymeric particle comprising:
at least one functionally active group that can interact with a biological probe;
at least one photographic coupler; and
a high boiling solvent.

25. The polymeric particle of claim 24 with a biological probe covalently or noncovalently attached.

26. The polymeric particle of claim 24, formed from styrenic polymers, acrylic polymers, or from a polyester-addition polymer hybrid.

27. The polymeric particle of claim 24 wherein the polymeric particles have a mean diameter of 1 to 50 microns.

28. The polymeric particle of claim 24 wherein the polymeric particles have a mean diameter of 3 to 30 microns.

29. The polymeric particle of claim 24 wherein the polymeric particles have a mean diameter of 5 to 20 microns.

30. The polymeric particle of claim 24 wherein the functionally active groups on the surfaces of the polymeric particles can interact with biological probes.

31. The polymeric particle of claim 24 wherein the functionally active group on the surfaces of the polymeric particles are carboxyl, amino, hydroxyl, hydrazide, amide, chloromethyl, epoxy, or aldehyde.

32. The polymeric particle of claim 24 wherein the biological probes are covalently or noncovalently attached to the surfaces of the loaded polymeric particles.

33. The polymeric particle of claim 24 wherein the coupler in the loaded polymeric particle can be developed to form a detectable color.

34. The polymeric particle of claim 33 wherein the photographic coupler is developed by interacting with oxidizing color developing agents to form cyan, magenta or yellow dyes.

35. The polymeric particle of claim 24 wherein the photographic coupler is a phenol or a naphthol that forms cyan dyes.

36. The polymeric particle of claim 24 wherein the photographic coupler is a pyrazolone, pyrazolotriazole, or pyrazolobenzimidazole that forms magenta dyes.

37. The polymeric particle of claim 35 wherein the dye-forming coupler is an open chain ketomethylene compound that forms yellow dyes.

38. The polymeric particle of claim 24 wherein the high boiling organic solvent is selected from the group of compounds consisting of alkyl phthalates, aryl phthalates, alkyl amides, phosphates, phenols, alcohols, sulfoxides, esters, hydrocarbons, alkyl halides, and epoxides.

39. The polymeric particle of claim 24 wherein the high boiling organic solvent is selected from the group of compounds consisting of diethyl phthalate, dibutyl phthalate, dipentyl phthalate, diisoamyl phthalate, dibenzyl phthalate, dimethoxyethyl phthalate, dibutoxyethyl phthalate, tributyl trimellitate, acetyltributyl citrate, tributyl citrate, tripentyl citrate, dimethyl sebacate, dibutyl sebacate, dibutyl adipate, dibutyl azelate, 1,4-cyclohexylenedimethylene bis(2-ethylhexanaoate), bis-ethylhexyl sulfoxide, triphenylphosphate, tricresylphosphate, trihexylphosphate, n-Hexylphenylcarbinol, 2-(p-tert, butylphenoxy)-ethanol, Acetyl n-butyl aniline, N-n-amyl succinimide, N,N-di-propyl dodecanamide, N-dodecyl pyrolidinone, di-tert amyl phenol, phenoxy toluene, ethylhexyl hydroxy benzoate, phenylethyl benzoate, ethylhexyltoluene sulfonamide, undecyl alcohol, oleyl alcohol, butyl methoxy benzoate, butyl phthalylbutyl glycollate, and N,N′-di-n-butyl urea.

40. An element for use in detecting biological analytes, the element comprising:
a support;
a receiving layer; on which are disposed the polymeric particles of claim 24.
